(19) United States
(12) Patent Application Publication
(10) Pub. No.: US 2026/0342554 A1
(43) Pub. Date: Oct. 29, 2026

(54) Methods and Procedures for a Quantum Communication Protocol for Multimodal Data Streaming and High Throughput Quantum Internet

(71) Applicant: Lakes Environmental USA Inc., Dallas, TX (US)

(72) Inventors: Jose R. Rosas Bustos, Waterloo (CA); Jesse Van Griensven Thé, Waterloo (CA)

(21) Appl. No.: 19/061,640

(22) Filed: Feb. 24, 2025

Related U.S. Application Data
(60) Provisional application No. 63/685,917, filed on Aug. 22, 2024.
(60) Provisional application No. 63/686,262, filed on Aug. 23, 2024.

(51) Int. Cl. H04L 9/08; G06F 1/12; H04B 10/70; H04L 9/32

(52) U.S. Cl. CPC H04L 9/0858; G06F 1/12; H04B 10/70; H04L 9/3215

(57) ABSTRACT

A system and method are provided for providing secure communications using a quantum communications system. A clock (e.g., an atomic clock) at a transmitter is synchronized with a clock at a receiver to coordinate seeds from the clocks to respective pattern generators at the receiver and transmitter. The pattern generators determine quantum state bases for the modulation (transmitter) and demodulation (receiver) of information onto quantum states of a quantum beam that is sent from the transmitter to the receiver. Thus, the modulation bases are known to the transmitter and receiver, but not to an eavesdropper. After demodulating the quantum beam, the receiver detects the quantum states of the demodulated beam to retrieve the information. The information can be a cryptographic key sent securely from the transmitter to the receiver. The quantum states can be qumodes with the information encoded in their quadratures, which are detected using homodyne/heterodyne detection.

### CROSS-REFERENCE TO RELATED APPLICATIONS

This application claims priority to and the benefit of U.S. provisional application No. 63/685,917, filed on Aug. 22, 2024, which is expressly incorporated by reference herein in its entirety. This application also claims priority to and the benefit of U.S. provisional application No. 63/686,262, filed on Aug. 23, 2024, which is expressly incorporated by reference herein in its entirety.

### BACKGROUND

Quantum Key Distribution (QKD) protocols, such as the Bennett and Brassard 1984 (BB84) protocol, the Ekert 1991 (E91) protocol (Ekert), and the Bennett, Brassard, and Mermin 1992 (BBM92), have been developed to use quantum properties to provide secure communication. These protocols utilize discrete quantum states and entangled qubits to establish secure communication channels. These protocols face several limitations, including scalability issues, susceptibility to specific types of attacks, and the necessity for classical communication for key sifting and error correction.

Bennett and Brassard proposed the BB84 protocol in 1984. It uses polarized photons to transmit keys securely but requires high error correction and privacy amplification. Artur Ekert introduced the E91 protocol in 1991. It leverages quantum entanglement and Bells inequality to ensure security. The BBM92 protocol adapts the BB84 protocol for entangled photon pairs.

Recent advancements have introduced continuous-variable QKD protocols, such as Gaussian-Modulated Coherent States (GMCS) and Continuous-Variable Squeezed States (CVSS). These protocols utilize continuous quadrature measurements, allowing for more efficient key generation. However, they still require classical post-process communication and are vulnerable to disruptions on the classical channels and specific quantum channel attacks.

Existing protocols have paved the way for secure quantum communication. However, there is a desire for quantum communications protocols with more adaptability and robustness to make feasible the emerging quantum Internet. Further, there is a desire for quantum communications protocols that can seamlessly integrate with new quantum technologies and that leverage existing, classical infrastructure (e.g., telecommunications infrastructure). An improved quantum communications protocol can also provide higher throughput and offer enhanced security features.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example of a quantum communications system in accordance with some embodiments.

FIG. 2A illustrates an example of encoding information from a code word onto polarization states in accordance with some embodiments.

FIG. 2B illustrates an example of decoding information from polarization states of a quantum beam in accordance with some embodiments.

FIG. 3 illustrates a flow diagram of an example of a method for providing secure communications using a quantum communications system in accordance with some embodiments.

FIG. 4 illustrates a block diagram of an example of a computing device, in accordance with some embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some aspects, the techniques described herein relate to a method, including: synchronizing a first clock provided at a transmitter with a second clock provided at a receiver; seeding, at the transmitter, a first pattern generator using the first clock to generate an encoding pattern; encoding, at the transmitter, a quantum beam in accordance with the encoding pattern to provide an encoded quantum beam; transmitting the encoded quantum beam from the transmitter through a channel to the receiver to provide a received quantum beam; seeding, at the receiver, a second pattern generator using the second clock to generate a decoding pattern; and detecting, at the receiver, quantum states of the received quantum beam in accordance with the decoding pattern to provide detected values.

In some aspects, the techniques described herein relate to a communication system including: a transmitter that includes: a first pattern generator that receives a seed, and, in response to the seed, generates an encoding pattern; a quantum source that generates a quantum beam including a series of quantum units, each quantum unit of the series quantum units in an initial quantum state; a first modulator that receives the encoding pattern and changes the initial quantum state of a quantum unit of the quantum beam to a modulated quantum state in a first basis that is based on the encoding pattern to provide a modulated quantum beam having quantum units in modulated quantum states in first bases, wherein the transmitter transmits the modulated quantum beam through a channel to a receiver.

In some aspects, the techniques described herein relate to a communication system including: a receiver that includes: a pattern generator that receives a seed, and, in response to the seed, generates a decoding pattern; a detector system that receives the decoding pattern and a modulated quantum beam, the detector system detecting modulated quantum states by measuring respective quantum units of the modulated quantum beam using respective measurement bases that are based on the decoding pattern to generate detected values, wherein the decoding pattern is coordinated with an encoding pattern of a transmitter that generates the modulated quantum beam, and the receiver receives the modulated quantum beam from the transmitter via a channel.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for a secure quantum communication systems and methods that more adaptability and robustness. Further, the systems and methods disclosed herein have the several benefit of being able to seamlessly integrate with new quantum technologies, being able to leverage current infrastructure, providing higher throughput, and offering enhanced security features. The systems and methods disclosed herein can provide these improvements by using dynamic modulation techniques, seed functionality for traffic decryption, and compatibility with various classical and quantum technologies, thus representing an advancement in the field.

Existing QKD systems face several challenges that are at least partially overcome by the systems and methods disclosed herein. For example, current QKD protocols, such as BB84, E91, BBM92, GMCS, and CVSS, exhibit several limitations that hinder their scalability and practical deployment. These several limitations include: (1) scalability issues; (2) security vulnerabilities; (3) integration challenges; (4) efficiency constraints; and (5) implementation complexity.

Regarding scalability issues, existing QKD and Quantum Communication protocols (“protocols”) require extensive classical communication for authentication, data transmission, key sifting and post-processing, which imposes a bottleneck on the overall communication process. This dependency limits the scalability of these protocols for large-scale quantum networks. Further, the need for robust error correction and privacy amplification mechanisms adds complexity and reduces the efficiency of key generation, making it difficult to scale up for extensive networks.

Regarding security vulnerabilities, current protocols are vulnerable to various attacks, including side-channel attacks, Denial of Service (DoS) attacks, and cloning or tempering attacks on the classical channel. These vulnerabilities compromise the security and reliability of quantum communication. Further, many existing protocols lack explicit mechanisms for real-time anomaly detection that rely 100% on the quantum channel, making them less robust against potential security breaches and performance issues.

Regarding integration challenges, compatibility with Quantum Technologies. Existing protocols often need to be more compatible with emerging quantum technologies, such as quantum repeaters, quantum memory, and quantum computing. Integration capability is necessary for the development of a cohesive Quantum Internet infrastructure. Further, current protocols face challenges in seamlessly integrating with quantum teleportation and repeater technologies, which are essential for long-distance quantum communication.

Regarding efficiency constraints, throughput Limitations. Traditional protocols typically suffer from low data throughput, limiting their practical application in high-demand environments. The need for continuous key generation and distribution can slow down the communication process. Further, existing protocols do not adequately support dynamic adaptation to varying network conditions and hardware capabilities, which is crucial for maintaining optimal performance in a dynamic quantum network environment.

Regarding implementation complexity, implementing current protocols requires sophisticated and often expensive hardware and software components, hindering widespread adoption. Further, the operational complexity of setting up and maintaining secure quantum communication channels using existing protocols can be prohibitively high for many practical applications.

The systems and methods disclosed herein can provide several improvements, including: (1) enhanced scalability; (2) improved security; (3) seamless integration with quantum technologies; (4) higher throughput; (5) dynamic adaptation; (6) reduced complexity and cost; (7) a future-proof design; (8) a hybrid approach for dual use; and (9) quantum encoding.

Regarding enhanced scalability, a Quantum Internet depends a protocol that can efficiently scale to support vast, interconnected networks. The systems and methods disclosed herein eliminate the dependence on classical communication in key sifting, and the systems and methods disclosed herein can use a streamlined key generation process that enhances scalability.

Regarding improved security, with increasing threats from advanced cyber-attacks, there is a paramount need for a protocol that offers superior security features. The systems and methods disclosed herein can be designed to resist side-channel, DoS, and cloning attacks, providing a more secure communication framework. Further, teal-time anomaly detection mechanisms within the systems and methods disclosed herein to provide prompt identification and mitigation of potential security breaches.

Regarding seamless integration with quantum technologies, the growing ecosystem of quantum technologies, including quantum repeaters, quantum memory, and quantum computing, necessitates a communication protocol that can integrate seamlessly with these advancements. The systems and methods disclosed herein can be compatible with these technologies to facilitate a unified and efficient Quantum Internet infrastructure. Further, the systems and methods disclosed herein can support quantum teleportation and repeaters, essential for long-distance quantum communication, addressing a gap in current protocols.

Regarding higher throughput, the increasing demand for high-speed data transmission in quantum networks underscores the need for a protocol to deliver higher throughput. The systems and methods disclosed herein can use dynamic modulation techniques and efficient key generation processes enable higher data transmission rates than existing QKD protocols.

Regarding dynamic adaptation, communication and data networks are dynamic and require protocols adapting to changing network conditions and hardware capabilities. The systems and methods disclosed herein can use dynamic modulation and real-time adaptation capabilities to ensure optimal performance and reliability, even in fluctuating environments.

Regarding reduced complexity and cost, to facilitate widespread adoption, a quantum communication protocol that reduces the complexity and cost associated with implementation is needed. The systems and methods disclosed herein can achieve reduced complexity and cost by simplifying the hardware and software requirements and minimizing operational complexity, making it accessible for broader applications.

Regarding the future-proof design, as quantum technologies continue to evolve, a communication protocol that can remain relevant and effective in the face of future developments is needed. The systems and methods disclosed herein uses an innovative design and forward-thinking architecture thereby providing a future-proof solution ready to meet the demands of the evolving Quantum Internet landscape.

Regarding the hybrid approach for dual use, the systems and methods disclosed herein can enable a hybrid approach where traditional digital and quantum-encoded data can be transmitted over the same conventional channel. This dual-use capability allows using existing traditional communication infrastructure without requiring exclusive quantum infrastructure, significantly lowering the barrier to adoption and enabling a more seamless transition to quantum-enhanced networks.

Regarding quantum encoding, the Quantum Communication Protocol provided by the systems and methods disclosed herein can use advanced quantum encoding techniques to facilitate the secure and efficient transmission of various data types in the same quantum channel, including qubits, qudits, qumodes, and digital information. This flexibility in encoding enables the protocol to support a wide range of quantum and classical communication applications.

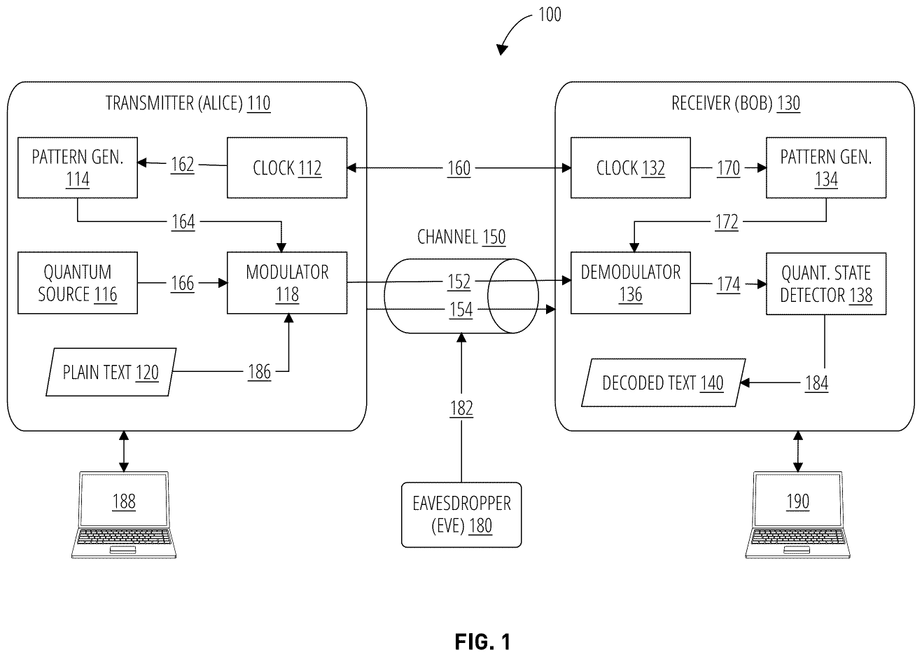

FIG. 1 illustrates quantum communications system 100, which is a non-limiting example of a quantum communication system. Quantum communications system 100 can be used for quantum key distribution but can also be used to directly encode code word 186 (e.g., code word 186 can be generated by applying an error correction code to plain text 120) onto quantum beam 152 to send code word 186 in a way that uses quantum mechanics to ensure security.

Quantum communications system 100 includes transmitter 110, receiver 130, and channel 150. Transmitter 110 generates quantum beam 152, which is transmitted to receiver 130 through channel 150. Receiver 130 selects a measurement basis, and the selected measurement basis is used to detect the quantum states of quantum beam 152. Quantum physics is relied on to ensure that the information conveyed by quantum beam 152 is secure against eavesdropping attack 182 from eavesdropper 180.

According to certain non-limiting examples, transmitter 110 includes synchronized timing device 112, pattern generator 114, quantum source 116, and modulator 118. Quantum source 116 produces a series of quantum elements 166 (e.g., photons) having respective quantum states. Modulator 118 modifies the quantum states of quantum elements 166 to generate quantum beam 152, which propagates from transmitter 110 through channel 150 to receiver 130.

Synchronized timing device 112 can be a clock (e.g., an atomic clock) that is synchronized with synchronized timing device 132 of receiver 130. Synchronized timing device 112 generates seed 162, which is sent to pattern generator 114. Based on the value of seed 162, pattern generator 114 determines modulation pattern 164 (e.g., a pattern of symbols, such as a binary string) that is applied to modulator 118 to determine a modulation pattern. Further, modulator 118 can receive a second input, code word 186, which is also used to determine how the quantum states of quantum elements 166 are modified.

For example, code word 186 can be generated by applying an error correction code to plain text 120. Transmitter processor 188 can be used to apply the error correction code to plain text 120 to generate code word 186. Further, transmitter processor 188 can be used for processing other information such as analyzing fluctuations in one or more fields propagating through the channels to detect anomalies, as discussed below. Additionally, transmitter processor 188 can determine whether channel 150 is compromised based on the analysis of the fluctuations and the detection of anomalies. Transmitter processor 188 can process data related to channel 150 to monitor properties of channel 150 to determine real-time conditions of the channel, and, based on the determined real-time conditions of the channel, determine how to dynamically adapt quantum beam 152 to optimize transmission through channel 150.

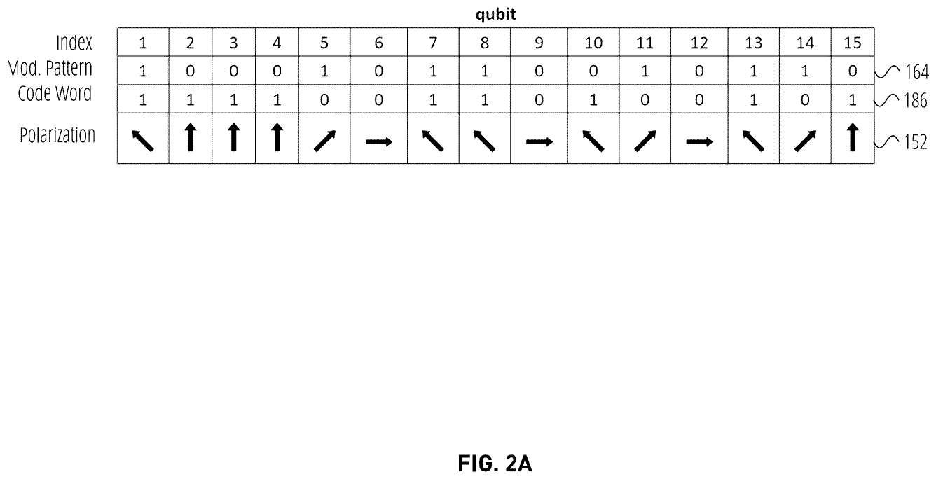

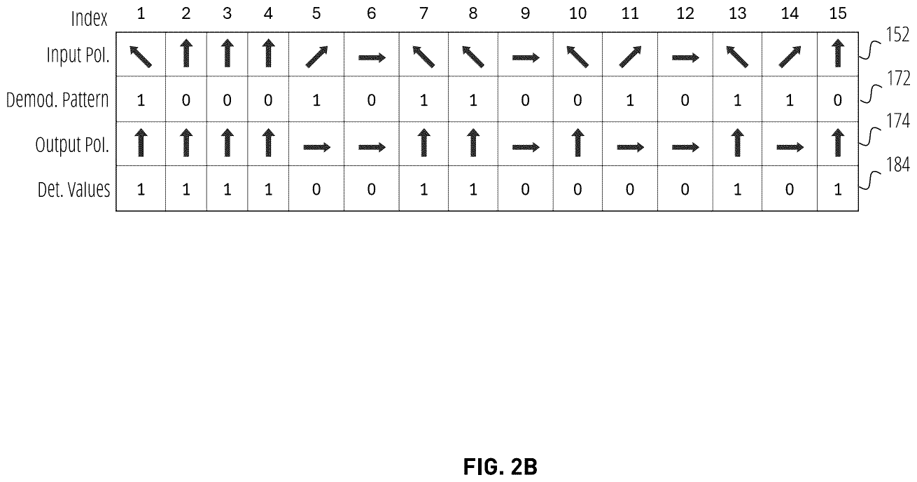

Consider a non-limiting example, which is illustrated in FIG. 2A and FIG. 2B, in which modulation pattern 164 and code word 186 are binary strings and the quantum states of quantum elements 166 are the linear polarizations of single photons. In this case, modulation pattern 164 can determine the measurement basis in which the quantum state is encoded and code word 186 can determine the quantum state of the quantum elements in the respective measurement basis. For example, a binary “0” of modulation pattern 164 can cause modulator 118 to encode the polarization in a 0°-90° measurement basis, and a binary “1” of modulation pattern 164 can cause modulator 118 to encode the polarization in a 45°-135° measurement basis. Given the specified basis, a binary “0” in code word 186 can cause modulator 118 to encode the photon in a horizontal polarization state |H> of the measurement basis (e.g., horizontally polarized), while a binary “1” in code word 186 can cause modulator 118 to encode the photon in a vertical polarization state |V> the measurement basis.

Table 1. An example of using modulation pattern 164 and code word 186 to generate modulated quantum states for quantum beam 152.

TABLE 1
An example of using modulation pattern 164 and code word 186
to generate modulated quantum states for quantum beam 152.
qubit

| | Index | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| Mod. | 1 | 0 | 0 | 0 | 1 | 0 | 1 | 1 | 0 | 0 | 1 | 0 | 1 | 1 | 0 |
| pattern | | | | | | | | | | | | | | | |
| Code | 1 | 1 | 1 | 1 | 0 | 0 | 1 | 1 | 0 | 1 | 0 | 0 | 1 | 0 | 1 |
| word | | | | | | | | | | | | | | | |
| Mod. Q. | [symbol] | ↑ | ↑ | ↑ | [symbol] | → | [symbol] | [symbol] | → | [symbol] | [symbol] | → | [symbol] | [symbol] | ↑ |
| state | | | | | | | | | | | | | | | |

Table 1 illustrates the modulated quantum states generated by modulator 118 for a series of binary values for the code word and a series of binary values for the quantum state. In this example, quantum source 116 can generate a series of single photons within respective time bins, and each photon from quantum source 116 can be in the vertical polarization state |V) for the 0°-90° measurement basis. Modulator 118 can be a series of phase plates (e.g., a quarter-wave plate (QWP) and a half-wave plate (HWP)). Between photon packets, which are used as the example of quantum units/elements, the wave plates are rotated to predefined angles thereby causing a rotation to the specified polarization state for a given quantum unit/element (e.g., the photon packet). Additional or alternatively, one or more electro-optic modulators can be used to change the polarization state of the respective photons (e.g., by inducing phase shifts between polarization modes). Electro-optic modulators have the relative benefit of rapid switching times (e.g., <20 Gbps switching rate, which is limited primarily by the resistance/capacitance (RC) time constant of the electro-optic modulator), whereas mechanically rotating physical wave plates can be slower.

The illustrative example of modulator 118 being used to modulate the polarization is non-limiting. For example, when quantum source 116 generates photons (e.g., in number states or in coherent states), modulator 118 can be used to modulate the polarization, amplitude, phase, time, frequency (energy), quadrature, position (quadrature), momentum (quadrature), squeezing, wave-number vector (\vec{k}), and a photon location (x). The quantized variable of quantum elements 166 (e.g., photons) that are modulated can be conjugate variables for which the Heisenberg uncertainty principle applies. A person of ordinary skill in the art will recognize that the types of modulation that can be performed by modulator 118 are not limited to the illustrative examples provided herein, and other types of modulation may be performed by modulator 118. Further, modulator 118 can include more than one modulating and optical components, including, for example, an electro-optic modulator, an acoustic-optic modulator, a balanced or an unbalanced Mach-Zehnder interferometer, one or more delay legs, a frequency modulator, a phase modulator, an amplitude modulator, one or more lenses, one or more prisms, and/or one or more diffraction gratings.

Further, quantum elements 166 can be modulated for other purposes in addition to preparing the quantum state. For example, when channel 150 allows wavelength division multiplexing (WDM) (e.g., there is a choice for which carrier frequency is used to transmit quantum beam 152), it can be advantageous to select for quantum beam 152 a frequency channel that is less noisy and/or has higher transmission than other frequency channels in the WDM. Selecting a less noisy/higher transmission frequency channel for quantum beam 152 can be realized by using modulator 118 to apply frequency modulation to shift the carrier frequency of the coherent states of quantum elements 166 to the central frequency of the less noisy frequency channel.

The above example of frequency shifting the carrier frequency of coherent states to correspond to a low-noise, high-transmission frequency channel, is a non-limiting example of how modulator 118 can be used to adapt quantum beam 152 based on the properties (e.g. transmission and noise properties) of channel 150. As discussed below, according to some examples, the channel properties can be periodically or continuously measured to determine real-time conditions of the channel, and the modulation performed by modulator 118 can be adjusted to dynamically adapt quantum beam 152 to optimize transmission through channel 150 based on the real-time conditions of channel 150. Another example of optimizing system performance by dynamically adapting quantum beam 152 based on real-time conditions can be to characterize which measurement subspaces have less noise and/or attenuation than other measurement subspaces and selecting a modulation scheme that uses the measurements subspaces having the more optimal characteristics (e.g., less noise and/or channel attenuation).

Channel 150 can be a communication channel, such an optical fiber or free space optical channel through which quantum beam 152 travels from transmitter 110 to receiver 130. As discussed above, channel 150 can be a plurality of channels, as in WDM, orthogonal frequency division multiplexing (OFDM), time division multiple access (TDMA), wavelength division multiple access (WDMA), etc., and some of these channels can be used to transmit quantum beam 152 while others are used to transmit classical communications 154. For example, classical communications 154 can be used for coordination and management functions between transmitter 110 and receiver 130. Further, classical communications 154 can be used for channel characterization or other purposes.

Receiver 130 receives quantum beam 152 and uses demodulator 136 to demodulate quantum beam 152, resulting in quantum elements 174. Like pattern generator 114 of transmitter 110, pattern generator 134 of receiver 130 uses a seed (e.g., seed 170) from a timing device (e.g., synchronized timing device 132) to generate a code word (e.g., demodulation pattern 172) that informs demodulator 136 how to demodulate quantum beam 152. For example, demodulator 136 converts the measurement bases of quantum beam 152 to the measurement basis of quantum state detector 138. Consider the above example in which the measurement bases of quantum beam 152 are the 0°-90° polarization basis and the 45°-135° polarization basis. When the measurement basis of quantum state detector 138 is the 0°-90° polarization basis, demodulator 136 can convert those quantum elements of quantum beam 152 that are in the 45°-135° polarization basis to the 0°-90° polarization basis and leave those quantum elements in the 0°-90° polarization basis unchanged. For example, a binary “1” in demodulation pattern 172 can cause demodulator 136 to rotate the polarization of the photon(s) from the 45°-135° polarization basis to the 0°-90° polarization basis, and a binary “0” in demodulation pattern 172 can cause demodulator 136 to leave the polarization of the photon(s) un changed (i.e., remaining in the 0°-90° polarization basis).

According to certain non-limiting examples, demodulation pattern 172 can be identical to modulation pattern 164 with a time delay corresponding to the propagation time through channel 150, especially when the basis states used for the measurements in quantum state detector 138 are the same as the basis states in which quantum source 116 generated quantum element 166. However, modulation pattern 164 does not have to be identical to demodulation pattern 172, and the basis states for quantum source 116 do not have to be identical for quantum state detector 138.

Next, quantum state detector 138 receives quantum elements 174 and generates detected values 184, and then detected values 184 can be used to generate decoded text 140. For example, when code word 186 is generated by applying an error correction code to plain text 120, decoded text 140 can be generated by applying error correction to detected values 184. When all errors in detected values 184 can be corrected, decoded text 140 can be identical to plain text 120.

For example, receiver processor 190 can be used to perform error correction to detected values 184 to generate decoded text 140. Further, receiver processor 190 can be used for processing other information such as analyzing fluctuations in one or more fields propagating through the channels to detect anomalies, as discussed below. Additionally, receiver processor 190 can determine whether channel 150 is compromised based on the analysis of the fluctuations and the detection of anomalies. Receiver processor 190 can process data related to channel 150 to monitor properties of channel 150 to determine real-time conditions of the channel, and, based on the determined real-time conditions of the channel, determine how to dynamically adapt quantum beam 152 to optimize transmission through channel 150.

Eavesdropper 180 can initiate eavesdropping attack 182 on channel 150 to try to intercept the information from code word 186. However, the quantum attributes of quantum beam 152 can provide provably secure communications. For single photon number states, for example, the no-cloning theorem can ensure that when eavesdropper 180 intercepts a symbol encoded on a quantum element (e.g., the polarization of a photon) of quantum beam 152, the effect of eavesdropping attack 182 can be detected and evasive action can be taken based on the detection. For example, plain text 120 can be a cryptographic key (e.g., a one time pad). In this case, upon detecting that a subset of the quantum elements of quantum beam 152 have been measured in eavesdropping attack 182, the appropriate action can be to distill the key to remove information that eavesdropper 180 may have obtained.

According to certain non-limiting examples, the quantum states used for quantum elements 166 and quantum elements 174 and used in quantum beam 152 are qumodes. Qumode are quantum modes in which the quantum unit/element have quantum states with degrees of freedom that are continuous. For example, the qumodes can optical fields (e.g., coherent states, such as a laser beam) and the quantum states can have degrees of freedom represented by the quadratures of optical fields (e.g., position and momentum). In this case, the quadratures can be changed by modulating the amplitude and phase of the optical field, which are continuous variables.

For example, beam can use qumodes in transformed and modulated states, including but not limited to vacuum states and near vacuum states. Qumodes can be used for channel authentication, quantum data encoding, facilitating high-throughput data streaming and robust quantum key distribution (QKD). Quantum communications system 100 (e.g., modulator 118 and demodulator 136) can use advanced dynamic modulation techniques, dynamic polarization, and Mode and Quantum Mode Decomposition Methods, including, but not exclusively, quantum transforms, such as the Quantum Fourier Transform (QFT), to enhance the reliability and efficiency of quantum communication.

According to certain non-limiting examples, quantum communications system 100 can use Gaussian-Modulated Coherent States (GMCS) and Continuous-Variable Squeezed States (CVSS).

According to certain non-limiting examples, quantum communications system 100 can use vacuum qumodes, near-vacuum qumodes, transformed vacuum qumodes, and modulated vacuum qumodes. The use of qumodes and variation thereof can provide improvements over GMCS and CVSS as the quantum states. For example, as discussed below, quantum communications systems 100 uses qumodes in novel and imitative ways that enhance security, reduce complexity, and improve adaptability.

According to certain non-limiting examples, transmitter 110 is responsible for generating and encoding the quantum information. As discussed above, transmitter 110 can include modulator 118, pattern generator 114, synchronized timing device 112, quantum source 116. Modulator 118 can be a first dynamic beam modulator that adjusts the properties of the quantum beams based on real-time conditions. Pattern generator 114 can be a first dynamic pattern generator that creates dynamic patterns for data encoding using synchronized atomic clocks. Synchronized timing device 112 can be a first atomic clock that provides precise timing for synchronization with the receiver. Quantum source 116 can be a quantum light source that generates qumodes in vacuum states or near vacuum states for encoding information. GMCS can be used in continuous-variable quantum key distribution, and they use coherent states of light that are modulated by a Gaussian distribution in one or both quadratures (amplitude and phase of the light field). CVSS can use squeezed coherent quantum states that reduce uncertainty in one quadrature (either the amplitude or the phase) of the electromagnetic field while increasing the uncertainty in the conjugate quadrature.

According to certain non-limiting examples, receiver 130 decodes and processes the quantum information. As discussed above, receiver 130 can include demodulator 136, pattern generators 134, synchronized timing device 132, and quantum state detector 138. Synchronized timing device 132 can be a second atomic clock that provides precise synchronization with transmitter 110. Pattern generator 134 can be a second dynamic pattern generator that uses synchronized patterns from the second atomic clock for decoding. Demodulator 136 can be a second dynamic beam modulator that matches the modulation patterns generated by the transmitter. Quantum state detector 138 can be a detection system that uses homodyne and heterodyne detection techniques to measure the quadratures of the received qumodes.

According to certain non-limiting examples, quantum communications system 100 can be initialized/setup and can be synchronized using the following steps. The setup process can begin with synchronizing synchronized timing device 112 and synchronized timing device 132 (e.g., the first and second atomic clocks). These clocks can be coordinated to provide precise timing and synchronization between transmitter 110 and receiver 130. Further, a fine timing measurement (FTM) can be used to determine the propagation time between transmitter 110 and receiver 130 through channel 150. According to certain non-limiting examples, the FTM protocol can be similar to that used for the WiFi standard (e.g., IEEE 802.11). The synchronized clocks generate a common seed (e.g., seed 162 and seed 170) used by the dynamic pattern generators at both the transmitter and receiver ends (e.g., pattern generator 114 and pattern generator 134). This ensures that both ends encode and decode the data using the same dynamic modulation patterns (e.g., modulation pattern 164 and demodulation pattern 172).

According to certain non-limiting examples, in the initial configuration, the transmitter and receiver are configured with the same initial parameters for quantum state preparation, modulation patterns, and detection settings. A secure channel is established and used for exchanging initial configuration data and verifying synchronization between the atomic clocks. For example, a previously established cryptographic key (e.g., a one-time pad) can be used to encrypt the information and send the encrypted information over classical communication channels to initialize the system. When quantum communications system 100 is initialized and operating securely using quantum communications, quantum communications system 100 can perform QKD to replenish/generate the amount of cryptographic key data (e.g., the number of bits of a one-time pad) that was consumed during the initialization of quantum communications system 100 can be replenished using QKD.

According to certain non-limiting examples, quantum data is transmitted for transmitter 110 to receiver 130 by encoding the data on quantum elements 166 by modulating the optical fields passing through modulator 118. For example, the transmitter generates quantum information by encoding data (e.g., code word 186) into the quadratures of qumodes using the dynamic beam modulator. The dynamic pattern generator creates dynamic modulation patterns based on the synchronized atomic clock. These patterns are used to modulate the qumodes dynamically, enhancing security and data integrity.

According to certain non-limiting examples, channel 150 of quantum communications system 100 performs hybrid transmission in which both quantum-encoded data and traditional digital data are transmitted simultaneously over the same communication channel. This hybrid approach leverages existing infrastructure (e.g., telecommunications fiber optics) and reduces the need for exclusive quantum channels.

According to certain non-limiting examples, receiver 130 of quantum communications system 100 performs decoding and detection. For example, receiver 130 can use dynamic modulation patterns to decode the received qumodes that are the same as the dynamic modulation patterns used at transmitter 110 to encode data on the qumodes. In this example, quantum state detector 138 can measure the quadratures, extracting the encoded information with high precision. Further, any discrepancies or anomalies in the received data can be detected in real-time, ensuring prompt identification and mitigation of potential security breaches.

According to certain non-limiting examples, quantum communications system 100 can perform key generation and management. For example, seeds can be extracted directly from the qumodes, bypassing the need for classical communication during key sifting. This method simplifies the key generation process and enhances scalability. Further, the extracted seeds can be used to generate cryptographic keys and ensure secure communication.

According to certain non-limiting examples, quantum communications system 100 can perform dynamic adaptation. For example, the protocol can dynamically adapt to changing network conditions and hardware capabilities, ensuring consistent performance and reliability. This includes adjusting modulation patterns and detection parameters in real time based on current channel conditions.

According to certain non-limiting examples, channel 150 of quantum communications system 100 performs various security features, including one-way continuous quantum channel authentication and real-time anomaly detection. For one-way continuous quantum channel authentication, the systems and methods disclosed herein can secure communication over single or multiple quantum channels without reciprocal authentication processes. For example, quantum communications system 100 can leverage the intrinsic randomness of quantum states and synchronized patterns to authenticate data transmission. Further, quantum communications system 100 can provide real-time adjustments to modulation patterns based on atomic clock synchronization to further enhance security. For real-time anomaly detection, the systems and methods disclosed herein can us integrated mechanisms to continuously monitor the quantum channel for anomalies. These mechanisms rely on the statistical properties of the qumodes and their quadrature measurements to detect and mitigate potential security breaches.

According to certain non-limiting examples, quantum communications system 100 can be integrated with other quantum technologies to provide various synergies and additional functionalities. For example, quantum communications system 100 can be integrated with one or more quantum repeaters and memories. Consider that the systems and methods disclosed herein are fully compatible with quantum repeaters and quantum memories, ensuring seamless integration within a cohesive Quantum Internet infrastructure. This compatibility supports long-distance quantum communication and data storage. Further, quantum communications system 100 can be integrated with quantum computing. For example, the features of quantum communications system 100 facilitates integration with quantum computing systems, enabling advanced quantum applications and processing.

As discussed above, according to certain non-limiting examples, modulator 118 and demodulator 136 can use qumodes in vacuum states or near vacuum states for encoding quantum information. This choice of quantum state supports continuous variable (CV) quantum communication, which is well-suited for high-capacity data transmission. Modulator 118 and demodulator 136 can be dynamic beam modulators that dynamically adjusts the properties of quantum beams 152 based on real-time conditions, ensuring optimal data integrity and transmission efficiency.

According to certain non-limiting examples, pattern generator 114 and pattern generator 134 can be dynamic pattern generators that generate complex patterns for data encoding, which are then modulated by the dynamic beam modulators. This combination allows for flexible and efficient data encoding and transmission.

According to certain non-limiting examples, synchronized Timing device 112 and synchronized timing device 132 can be atomic clocks. Synchronized Timing device 112 and synchronized timing device 132 can be two precisely coordinated time synchronization devices, such as atomic clocks. Each transmitter and receiver possesses one of these synchronized atomic clocks. The synchronized atomic clocks are used by the pattern generator to produce a common seed for data encoding and decoding, ensuring precise and synchronized operations between the transmitter and receiver.

According to certain non-limiting examples, quantum communications system 100 can use hybrid data transmission. For example, channel 150 can enable the simultaneous transmission of traditional digital and quantum-encoded data over the same communication channel. This hybrid approach leverages existing infrastructure, reducing the need for exclusive quantum channels and facilitating a smoother transition to quantum-enhanced networks.

According to certain non-limiting examples, quantum communications system 100 can provide cryptographic key generation and management. For example, in contrast to other QKD protocols that rely on classical communication for key sifting, the systems and methods disclosed herein can extract seeds directly from the qumodes. For example, plain text 120 and decoded text 140 can be the cryptographic key that is sent from transmitter 110 to receiver 130 without sifting. This method simplifies the key generation process and eliminates the dependency on classical post-processing. According to certain non-limiting examples, quantum communications system 100 can provide dynamic adaptation. For example, the systems and methods disclosed herein can adapt dynamically to changing network conditions and hardware capabilities, ensuring consistent performance and reliability.

According to certain non-limiting examples, quantum communications system 100 can enable mode and quantum mode decomposition processes and dynamic modulation. For example, the systems and methods disclosed herein can employ mode and quantum mode decomposition processes, including, but not limited to, the Quantum Fourier Transform (QFT) to enhance the encoding and transmission of quantum data, enabling higher data throughput and more efficient use of the communication channel. Regarding dynamic modulation, the systems and methods disclosed herein can use dynamic modulation techniques to continuously adjust the encoding parameters, optimizing data transmission in real time.

According to certain non-limiting examples, quantum communications system 100 can enable respective security features, including, one-way continuous quantum channel authentication and real-time anomaly detection. Regarding one-way continuous quantum channel authentication, the systems and methods disclosed herein can use an authentication method that secures communication over single or multiple quantum channels without the need for reciprocal authentication processes. This method can adapt to evolving channel characteristics in real time to provide enhanced security and efficiency. Regarding real-time anomaly detection, integrated anomaly detection mechanisms can be used to continuously monitor the quantum channel (e.g., the channel in channel 150 that is used for quantum beam 152) for potential security breaches, enabling prompt identification and mitigation of threats.

According to certain non-limiting examples, quantum communications system 100 can enable native quantum teleportation. For example, the systems and methods disclosed herein can facilitate native quantum teleportation by allowing the encoding of classical information in the quantum channel or by enabling the simultaneous transmission of quantum data and classical information within the same traditional channel. Quantum teleportation can see the transmission of classical data alongside quantum data to complete the teleportation process. This dual capability ensures that both types of data can be transmitted efficiently, leveraging existing communication infrastructure while providing the high security and fidelity required for quantum teleportation. This integration is key to enabling robust and efficient quantum networks, where classical control information and quantum states can be transmitted together, streamlining operations and enhancing the overall functionality of the Quantum Internet.

### Continuous Variable Quantum States

According to certain non-limiting examples, quantum communications system 100 can use continuous variable quantum states. Unlike discrete variable quantum systems with finite-dimensional Hilbert spaces like qubits, continuous variable (CV) quantum states utilize infinite-dimensional spaces. This enables encoding more information per photon while leveraging optical-communication technologies (e.g., technologies for modulating classical optical fields for telecommunications).

For example, the fundamental CV carriers can be quantum harmonic oscillators or qumodes. The qumodes can be represented using quantized vibrational states that are described in quantum field theory using annihilation and creation operators acting on Fock states (i.e., number states). The position and momentum operators follow Heisenberg uncertainty relations.

In optical implementations, the qumode quadrature amplitudes \hat{X} and \hat{P} correspond to the electromagnetic field amplitudes. Homodyne detection measures \hat{X} or \hat{P} through interference with a local oscillator.

According to certain non-limiting examples, the systems and methods disclosed herein can use photon number states, coherent states, squeezed states, and/or entangled Einstein-Podolsky-Rosen (EPR) pairs for transmitting and modulating continuous variable quantum information. Advanced CV techniques can be used to provide the foundations for scalable high-speed quantum communication.

### Wavelength Division Multiplexing

According to certain non-limiting examples, quantum communications system 100 can use wavelength division multiplexing (WDM) in channel 150 to provide data transmission including both quantum channels and classical channels in the same infrastructure. WDM allows multiple signals to be transmitted simultaneously over an optical fiber by modulating each signal on a different wavelength channel.

The systems and methods disclosed herein can leverage WDM to independently modulate information on multiple spectral modes or “qumodes” of the electromagnetic field. In CV communication, each qumode encodes information in the infinite-dimensional Hilbert space of a quantum harmonic oscillator rather than discrete qubits or qudits.

Optical multiplexers combine the wavelength qumodes into a composite quantum signal. At the receiver, demultiplexers separate the qumodes into independent quantum channels. This parallel transmission boosts capacity and security through spatial resource multiplexing without discretization.

Advanced photon-efficient WDM techniques modulate properties like phase, polarization, and orbital angular momentum across the qumodes. By harnessing multi-wavelength quantum carriers, the systems and methods disclosed herein can achieve scalable high-dimensional CV quantum communication.

### High-Dimensional Hilbert Space Encoding

According to certain non-limiting examples, modulator 118 in quantum communications system 100 can encode code word 186 on quantum elements 166 using high-dimensional Hilbert space encoding. Discrete quantum systems like qubits are restricted to low-dimensional state spaces like 2×2 matrices. Continuous variable quantum states can use the infinite dimensionality of harmonic oscillator Hilbert spaces for encoding.

the systems and methods disclosed herein can leverage the high-dimensional Hilbert space provided by continuous variable quantum states to achieve high-dimensional encoding. For example, the position and momentum eigenstates of each qumode can span an infinite state space. Optical schemes further combine multiple degrees of freedom like polarization, orbital angular momentum, and spatial modes to enhance encoding capacity. For example, the space of possible quantum states in which to encode quantum elements 166 can be represented as a multi-dimensional space, with qumode states along a first axis, polarization along a second axis, orbital angular momentum (with conjugate variable phase) along a third axis, spatial modes (e.g., position-momentum conjugate variables) along a fourth axis, frequency (e.g., frequency/energy-time conjugate variables) along a fifth axis, etc.

According to certain non-limiting examples, efficient high-dimensional encoding can be realized using geometric transformations of optical quantum states. For example, modulator 118 can encode the information of code word 186 on quantum elements 166 by using various modulation techniques to perform operations on the optical fields, including, but not limited to, squeezing, displacing, and rotating the quadrature amplitudes of a qumode state vector thereby transforming each quantum element (e.g., a coherent state for an optical field) into a unique superposition state. Homodyne detection performed by quantum state detector 138 can be used to discriminate between the high-dimensional CV encodings. For example, demodulator 136 can reverse operations performed by modulator 118 to select the measurement bases based on modulation pattern 164, and quantum state detector 138 can use homodyne detection to detect the quantum state (e.g., the qumode) that encodes one or more symbols of code word 186.

By harnessing the possibility for Hilbert spaces with high dimensionality provide by using qumodes, the systems and methods disclosed herein can provide a scalable high-capacity platform for quantum communication networks that is an improvement over existing qubit-based approaches.

### Quantum Entanglement

According to certain non-limiting examples, the systems and methods disclosed herein can use quantum entanglement to realize various advantages. Quantum entanglement is a phenomenon where quantum states of two or more objects are described with reference to each other, even when separated by large distances. This non-local correlation is a fundamentally quantum effect with no classical analog.

Continuous variable entanglement deals with infinite-dimensional Hilbert spaces. Common examples are Einstein-Podolsky-Rosen (EPR) pairs of position/momentum or amplitude/phase entangled optical qumodes. These exhibit “spooky action at a distance” where measuring one qumode instantaneously collapses the state of the entangled partner.

The systems and methods disclosed herein can leverage CV entanglement to enable intrinsically secure quantum communication. Entangled qumodes act as a shared resource between the transmitter and receiver. Attempted eavesdropping introduces anomalies that can be detected using one or more entanglement verification measurements (similar to the Bell inequalities). This reveals the presence of an attack on the quantum channel without destroying the entanglement itself. Teleporting unknown quantum states is also enabled by using entanglement as a quantum channel.

Methods for distributing, verifying, and storing entanglement are active research areas. The systems and methods disclosed herein can use quantum repeaters and entanglement swapping to overcome limits on direct transmission distances. Exploiting quantum entanglement enables the systems and methods disclosed herein to achieve provably secure communication.

### Quantum Noise Analysis

According to certain non-limiting examples, the systems and methods disclosed herein can use quantum noise analysis. Quantum communication channels exhibit intrinsic noise due to the probabilistic nature of quantum states. Photon loss, damping, amplification, and other processes introduce uncertainties.

The systems and methods disclosed herein can use quantum noise analysis to model channel performance. Theoretical noise models quantify decoherence, dissipation, and other noise effects. Engineering quantum channels uses capacity theorems based on signal-to-noise ratios.

Continuous monitoring of quantum fluctuations enables the detection of anomalies arising from eavesdropping or interference. Noise levels exceeding modeled values indicate potential tampering. Randomized modulation provides further authentication by masking the quantum signal.

By combining analytical noise models with real-time fluctuation tracking, the systems and methods disclosed herein can identify deviations to maintain secure ultra-low noise performance. This resiliency against environmental and attack-based noise is a key advantage of the protocol.

### Quantum Fluctuations

According to certain non-limiting examples, the systems and methods disclosed herein can use quantum fluctuations. Quantum systems exhibit inherent uncertainties and fluctuations arising from conjugate variables as described by the Heisenberg uncertainty principle. Even in idealized isolated environments, quantum states feature fluctuations around expected values.

In continuous variable quantum communication, common fluctuations manifest as noise in qumode quadrature amplitudes and photon numbers. However, fluctuations can arise between any conjugate observables like energy/time, angular momentum/angle, etc. The variance in repeated measurements of any conjugate observables will reveal these intrinsic quantum fluctuations.

Tracking fluctuations in real time enables monitoring the quantum channel for anomalies. Sudden changes in variance levels can indicate environmental disturbance or adversarial tampering (e.g., eavesdropping attack 182).

By combining analytical noise models with active fluctuation tracking, the systems and methods disclosed herein can use data-driven authentication to verify the integrity of the quantum channel of channel 150 that is used to transmit quantum beam 152. Quantum fluctuations provide a signature for validating the transmission of true quantum states.

### Transmitter

According to certain non-limiting examples, transmitter 110 generates and encodes the continuous variable quantum states for communication using coherent laser sources and squeezers coupled to the quantum channel.

Wavelength division multiplexing enables preparing quantum states in parallel across distinct optical qumodes. Optical parametric oscillators produce squeezed states with quadrature entanglement. Electro-optic, acousto-optic, and electro-absorption modulators apply desired encodings.

According to certain non-limiting examples, synchronized timing device 112 and synchronized timing device 132 can be atomic clocks that provide synchronized randomness for modulating quantum states. Shared secret seeds (e.g., seed 162 and seed 170) enable intrinsically secure authentication. Based on the seeds, the measurement basis can be randomized for modulator 118 and demodulator 136. Modulator 118 can use various types of modulation such as phase, polarization, and orbital angular momentum modulation to encode information robustly.

According to certain non-limiting examples, Quantum Pings (QPings) are created by sending transformed qumode vacuum or near vacuum states to monitor the quantum channel.

According to certain non-limiting examples, integrated photonics implementations can allow miniaturized, scalable transmitters. Chip-scale devices can generate and manipulate thousands of qumodes for high throughput. Transmitters 110 can use advanced nanophotonic components to provide compact, efficient transmitters.

### Quantum Channel

According to certain non-limiting examples, the quantum channel (e.g., channel 150) transmits the continuous variable quantum states (e.g., quantum beam 152) between the remote transmitting and receiving nodes (e.g., transmitter 110 and receiver 130). The systems and methods disclosed herein can use fiber optic and/or free-space links for channel 150.

Optical fibers provide low-loss guided transmission of quantum light. Ultra-low loss single-mode fibers can be used to maximize range. Quantum repeaters using entanglement swapping can be used to extend the transmission range.

Free-space channels use atmospheric or space links for line-of-sight transmission. Adaptive optics can be used to compensate for turbulence, for example. Satellite links can enable global-scale quantum communication.

The quantum channel can be engineered for high spectral efficiency matching the qumode structure. WDM multiplexer/demultiplexer (mux/demux) can align channels with allocated bandwidths. Environmental isolation can be used to maintain stable ultra-low noise performance.

### Receiver

Receiver 130 can measure and decode the continuous variable quantum states after transmission through the quantum channel (e.g., channel 150). This detection process performed by demodulator 136 and quantum state detector 138 can involve quantum measurements, demultiplexing, and digital signal processing.

For example, balanced homodyne detectors measure quadrature amplitudes of the qumodes. Demultiplexing can be used to separate the spatially multiplexed channels.

Analog-to-digital converters (ADCs) can be used to digitize the homodyne measurements at high sampling rates. Digital signal processing (DSP) algorithms can be used to extract the encoded information and apply error correction procedures. Integrated photonic implementations can be used to provide chip-scale receivers.

The receiver leverages real-time quantum state tracking to monitor noise and fluctuations. Deviations can indicate eavesdropping or interference, triggering security protocols. Time synchronization can ensure that seed 162 matches seed 170, which can be used to authenticate valid quantum states.

### Shared Randomness Generation

Shared random secret keys can be used to provide intrinsically secure communication in the systems and methods disclosed herein.

The systems and methods disclosed herein use transmitter 110 and receiver 130 that each have access to synchronized atomic clocks (e.g., synchronized timing device 112 and synchronized timing device 132). These can be atomic clocks that allow the nodes to derive a shared random pattern (e.g., modulation pattern 164 and demodulation pattern 172) without needing to generate and distribute unique keys for each transmission.

The shared pattern can be continually refreshed following a security protocol to prevent potential physical attacks aimed at reverse engineering the pattern. The synchronized atomic clocks provide precision timing alignment to ensure proper encoding/decoding using the updated random seeds in the systems and methods disclosed herein.

### Homodyne/Heterodyne Detection

The systems and methods disclosed herein can use quantum optical detectors to measure the continuous variable quantum states after transmission through the quantum channel. For example, homodyne and/or heterodyne detection schemes can be utilized.

Balanced homodyne detectors can be used to measure quadrature amplitudes of the quantum states with low noise. Local oscillator beams at the carrier frequency are mixed with the signals. This provides amplitude and phase information.

Heterodyne detection uses a local oscillator at a different frequency than the carrier frequency of quantum beam 152, resulting in amplitude/phase data for additional sidebands. Applying digital signal processing to the measured output can provide full-field characterization, enabling the reconstruction of quantum states from the classical data.

High-speed, high-efficiency photodiodes sensitive to single photons can detect the mixed optical signals. Integrated photonic implementations on photonic chips are promising for the development of chip-scale receivers.

### Real-Time Fluctuation Tracking

The systems and methods disclosed herein can use real-time tracking of quantum fluctuations to monitor and authenticate the quantum channel. Fluctuations in quadrature amplitudes and photon numbers can be analyzed for anomalies. Quantum fluctuations intrinsically arise from the probabilistic nature of quantum states. The variance of repeated measurements can be used to track these uncertainties. By combining analytical noise models with active tracking of fluctuations, the receiver can validate the integrity of the quantum states. Sudden changes in the variance can provide a warning of potential eavesdropping or interference.

Field programmable gate arrays (FPGAs) can be used for high-speed, real-time signal processing to extract fluctuations for analysis. Machine learning techniques can be used to optimize authentication protocols. Continuous authentication via fluctuations can provide an additional layer of security for the systems and methods disclosed herein. This leverages intrinsic quantum signatures, which are present even in complex network environments.

### Quantum Noise Monitoring

The systems and methods disclosed herein can use continuous monitoring of inherent quantum noise to detect potential eavesdropping or interference. Fluctuations in the quadrature amplitudes reveal the probabilistic nature of the quantum states. Quantum noise can arise from fundamental uncertainties described by Heisenberg's uncertainty principle. This intrinsic randomness can be harnessed to enhance security. Measurements from receiver 130 can be used track noise levels in the quadrature amplitudes in real-time across the quantum channel. Changes in the quantum noise variance outside of expected levels indicate deviations in the quantum states, triggering security protocols.

Machine learning techniques can be used to optimize noise authentication by modeling channel characteristics. Through the selection of the system design, ultra-low noise performance can be maintained for high sensitivity. Quantum noise monitoring can provide a built-in mechanism for the systems and methods disclosed herein to validate the integrity of the quantum states. This leverages the quantum uncertainties to protect against hacking attempts.

### Continuous Fluctuation Tracking

In addition to quantum-noise monitoring, the systems and methods disclosed herein can use real-time tracking of fluctuations in the continuous variable quantum states of quantum beam 152 from transmitter 110. Ongoing analysis of variance can be used to monitor deviations from expected quantum behavior. Fluctuations are an intrinsic signature of quantum states stemming from probabilistic uncertainties as required by the Heisenberg uncertainty principle.

According to certain non-limiting examples, transmitter 110 can monitor the fluctuations by tapping/diverting a portion of quantum beam 152 using a beamsplitter. According to certain non-limiting examples, the diverted portion of quantum beam 152 is entangled with the transmitted portion of quantum beam 152.

Although the two output beams exhibit quantum correlations in their fluctuations due to entanglement, the transmitter does not directly measure the entanglement itself. Instead, transmitter 110 sends the diverted part of quantum beam 152 to a homodyne detector, which measures its field quadratures. This reveals information about the quantum noise and fluctuations in that diverted part of quantum beam 152. Because the fluctuations are correlated between the entangled beams, monitoring the diverted beam provides data on fluctuations in the main part of quantum beam 152, which passes through channel 150 to receiver 130. The measurements by transmitter 110 on the diverted part of quantum beam 152 do not affect or disturb the transmitted part of quantum beam 152.

By continuously tracking the fluctuations via homodyne detection of the diverted beam, the transmitter can authenticate the quantum states without needing feedback from the receiver. This allows the detection of potential eavesdropping attacks while the data transmission remains undisturbed. Because fluctuations are inherent attributes of the quantum states, the transmitter can track them without needing feedback from the receiver. This provides enhanced security without requiring a classical communication channel. The transmitter can extract real-time statistics on the quadrature amplitude and phase fluctuations of the quantum channel. Machine learning and Quantum Machine Learning techniques can optimize authentication protocols to identify anomalies.

Sudden changes in the fluctuation levels outside of modeled channel behavior can trigger transmitter 110 to refresh the shared secret keys (e.g., modulation pattern 164). This defends against potential eavesdropping attempts. For example, pattern generator 114 can have a set of algorithms/patterns that can be used to generate modulation pattern 164 based on seed 162. Further, pattern generator 134 can have the same set of algorithms/patterns that can be used to generate demodulation pattern 172 164 based on seed 170. When it is determined that a currently used algorithm/pattern may be compromised, a signal can be sent to pattern generator 114 and pattern generator 134 to switch to the next algorithm/pattern in the shared set of algorithms/patterns.

Continuous tracking of quantum fluctuations by the transmitter gives the systems and methods disclosed herein an embedded method to validate the integrity of transmitted quantum states. This leverages quantum uncertainties to enhance security.

### Resilience Against Attacks

The systems and methods disclosed herein can provide resilience against various cyberattack vectors by leveraging the self-authentication capabilities of the quantum channel. For example, continuous monitoring of fluctuations enables detecting denial of service attacks and selectively discarding only compromised portions of the quantum data.

For example, the systems and methods disclosed herein can use a high-dimensional CV protocol, making complete denial of service attacks difficult compared to qubit-based QKD. Further, quantum communications system 100 can monitor the noise power spectrum and fluctuations to detect potential eavesdropping attempts.

Quantum communications system 100 can use post-processing to discard potentially compromised subsets of the data before key generation. According to certain non-limiting examples, attempted tampering introduces anomalies that are rapidly identified, allowing the affected portions of the quantum data to be discarded. The no-cloning theorem prevents perfect man-in-the-middle attacks without introducing detectable errors.

Quantum communications system 100 can use monitoring of the characteristic of channel 150 to avoid reliance on fragile classical channels (e.g., by dynamically adapting the modulation scheme based on real-time measurements of the channel conditions), thereby allowing the systems and methods disclosed herein to enhance resistance to denial of service, eavesdropping, tampering, and man-in-the-middle attacks. The quantum channel (e.g., channel 150) can provide intrinsic self-authentication capabilities.

The systems and methods disclosed herein can provide resistance to Denial of Service (DoS) attacks. Quantum communications system 100 can continuously authenticate the quantum channel by monitoring fluctuations, enabling quantum communications system 100 to detect when an attacker is overwhelming the link by injecting noise or excess photons. This allows selectively discarding only the compromised subsets of the quantum data stream instead of the entire batch. Fine-grained control over discarding small portions of the quantum data prevents DoS attacks from being able to overwhelm the system and shut down communication. Additionally, the high dimensionality of the CV protocol makes it harder to fully deny service compared to qubit-based systems. For example, a DoS at some frequencies can be avoided by switching to frequencies that are not being attached and filtering out the photons as the attached frequencies. Even when a partial DoS degrades channel 150, some capacity (e.g., channels, modulation schemes, etc.) can still remain for transmitting data.

According to certain non-limiting examples, the systems and methods disclosed herein can provide resistance to eavesdropping. By monitoring the noise power spectrum and quantum fluctuations for increases over the standard quantum limit, quantum communications system 100 can detect eavesdropping attacks in which eavesdropper 180 is trying to extract information from quantum beam 152. Post-processing of the detected values 184 from quantum elements 174 can be performed using two-universal hashing to thereby discard portions of detected values 184 that may have been compromised before key generation, preventing eavesdropper 180 from accessing any private information. Multidimensional encoding means eavesdropper 180 has to correctly reconstruct more parameters to successfully eavesdrop without being detected.

The systems and methods disclosed herein can provide resistance to tampering. Authentication of the continuous quantum channel ensures any tampering of the quantum states, such as interference or state manipulation, will be rapidly detected as an anomaly. Tampering will introduce excess noise and fluctuations outside the quantum limits, triggering the identification of the tampered portions, which can then be selectively discarded. Attempted tampering is, therefore, ineffective and does not compromise the integrity of the generated secret keys.

The systems and methods disclosed herein can provide resistance to Man-in-the-Middle attacks. The no-cloning theorem of quantum mechanics prevents an adversary (e.g., eavesdropper 180) from perfectly copying quantum states to insert themselves into the link without introducing detectable anomalies. Continuous authentication enables legitimate users to identify attempts to impersonate the transmitter or receiver.

Advantages provided by the systems and methods disclosed herein include, but are not limited to:
The quantum channel is self-authenticated based on the shared random dynamic pattern, without classical communication.
There is no need for computationally intensive privacy amplification, authentication codes, or other classical post-processing.
Immunity to man-in-the-middle attacks since no classical channel is required.
Enhanced resistance to DoS attacks by avoiding reliance on fragile classical channels.

### Quantum Channel Authentication

The systems and methods disclosed herein can perform quantum channel authentication using the techniques discussed below. For example, quantum communications system 100 can perform quantum channel authentication using only quantum transmission (e.g., quantum beam 152) without relying on classical communication channels (e.g., classical communications 154). For example, transmitter 110 and receiver 130 can continuously monitor quantum beam 152 to detect anomalies in the quantum states passing through channel 150.

The quantum signals exhibit intrinsic fluctuations and noise stemming from quantum uncertainties. Changes in these quantum signatures warn of potential eavesdropping or tampering.

No classical communication is required between the nodes for this authentication. Instead, a shared secret seed (e.g., modulation pattern 164 and demodulation pattern 172) derived from the synchronized timing devices (e.g., synchronized timing device 112 and synchronized timing device 132) allows each node to independently monitor channel integrity.

The dynamic quantum channel authentication provides real-time validation of the security. Classical post-processing for privacy amplification can be avoided, reducing complexity.

By leveraging quantum properties, the systems and methods disclosed herein can provide seamless authentication without the fragility of classical channels. Quantum uncertainties are transformed into assets for protection.

### No Reliance on Classical Channels

As discussed above, one advantage of the systems and methods disclosed herein is that supplementary classical communication channels are not necessary for authentication and security in existing quantum communication protocols, whereas many other QKD protocols require an additional public classical channel. The use of such a classical channel can introduce vulnerabilities, undermining quantum security. Adversaries can target the classical channel for denial-of-service attacks or tampering.

The systems and methods disclosed herein can intrinsically integrate quantum channel authentication based on monitoring inherent quantum signatures. No classical channel is necessary for transmitting authentication codes or other metadata. Avoiding fragile classical channels enhances robustness against active hacking attempts. Security resources can focus on protecting the quantum channel alone. Thus, the self-contained quantum channel maintains high speeds securely. Classical communication bottlenecks and security liabilities are eliminated through the quantum-only design.

### Modulation Based on Shared Random Patterns

The modulation scheme used by modulator 118 to modulate quantum element 166 and generate quantum beam 152 can use shared random patterns (e.g., modulation pattern 164 and demodulation pattern 172) to vary the quantum state parameters continuously, thereby providing a defense against eavesdropping attacks.

The shared random patterns can be generated by transmitter 110 and receiver 130 using their synchronized atomic clocks to seed a deterministic random number generator (e.g., a quantum random number generator), thereby producing a dynamic random sequence. This dynamic random sequence is a shared secret pattern that is used to control the modulation. For example, the shared secret pattern can be used to control the modulation by changing the amplitude and phase of the quantum states based on the shared secret pattern.

To eavesdropper 180 the resulting quantum beam 152 appears unpredictable, but to receiver 130 modulation pattern is deterministic. Any attempt by eavesdropper 180 to intercept the transmission will inevitably introduce anomalies in quantum beam 152 that can be detected at receiver 130.

Thus, the shared random modulation can be used to monitor the integrity of channel 150 and quantum beam 152, allowing the systems and methods disclosed herein detect eavesdropping attacks without depending classical communications 154 between the transmitter and the receiver.

FIG. 2A illustrates a non-limiting example of modulator 118 modulating quantum elements 166 to generate quantum beam 152. In this example, quantum elements 166 are photons and the information is encoded in the polarization. For example, quantum source 116 can generate a series of 15 photon packets or qubits each in a single-photon Fock/number state with polarization in the horizontal polarization state |H> of the 0°-90° basis. Based on code word 186 and modulation pattern 164, modulator 118 (e.g., one or more electro-optic modulators and/or one or more wave plates) changes the polarization to the polarizations shown for quantum beam 152. Here, a binary “0” of modulation pattern 164 can cause modulator 118 to encode the polarization in a 0°-90° basis, and a binary “1” of modulation pattern 164 can cause modulator 118 to encode the polarization in a 45°-135° basis. Further, a binary “0” in code word 186 causes modulator 118 to encode the photon in a horizontal polarization state |H) of the basis (i.e., | [symbol] > for the 0°-90° basis and | [symbol] > for the 45°-135° basis). A binary “1” in code word 186 causes modulator 118 to encode the photon in a vertical polarization state |V> the basis (i.e., |↑> for the 0°-90° basis and | [symbol] > for the 45°-135° basis).

FIG. 2B illustrates a non-limiting example of demodulator 136 demodulating quantum beam 152 to generate quantum elements 174, and quantum state detector 138 measuring the quantum states of quantum elements 174 to generate detected values 184. Demodulation pattern 172 matches modulation pattern 164 because the respective timing devices of transmitter 110 and receiver 130 are synchronized. A binary “0” in demodulation pattern 172 causes demodulator 136 to leave the basis of the quantum state unchanged. A binary “1” in demodulation pattern 172 causes demodulator 136 to rotate the basis from the 45°-135° basis to the 0°-90° (e.g., state | [symbol] > becomes state | [symbol] > and state | [symbol] > becomes state |↑>).

Next, quantum elements 174 output from demodulator 136 are measured by quantum state detector 138. Measurements of state | [symbol] > generate a binary “0,” and measurements of state |↑> generate a binary “1.”

The use of polarization states to encode information on quantum beam 152 is a non-limiting example, and a person of ordinary skill in the art will recognize that other quantum states and modulation schemes can be used.

For example, quantum elements 166 can be qumodes, and modulator 118 can use phase and amplitude modulation to encode 3-bit segments of code word 186 onto a qumode by modulating the qumode to be in one of eight possible quadrature states for a basis specified by modulation pattern 164. Also, the dimensionality of the qumode can be scaled up to having 16 possible quadrature states for encoding 4-bit segments of code word 186. Or, the dimensionality of the qumode can be scaled up to having 32 possible quadrature states for encoding 5-bit segments of code word 186, and so forth.

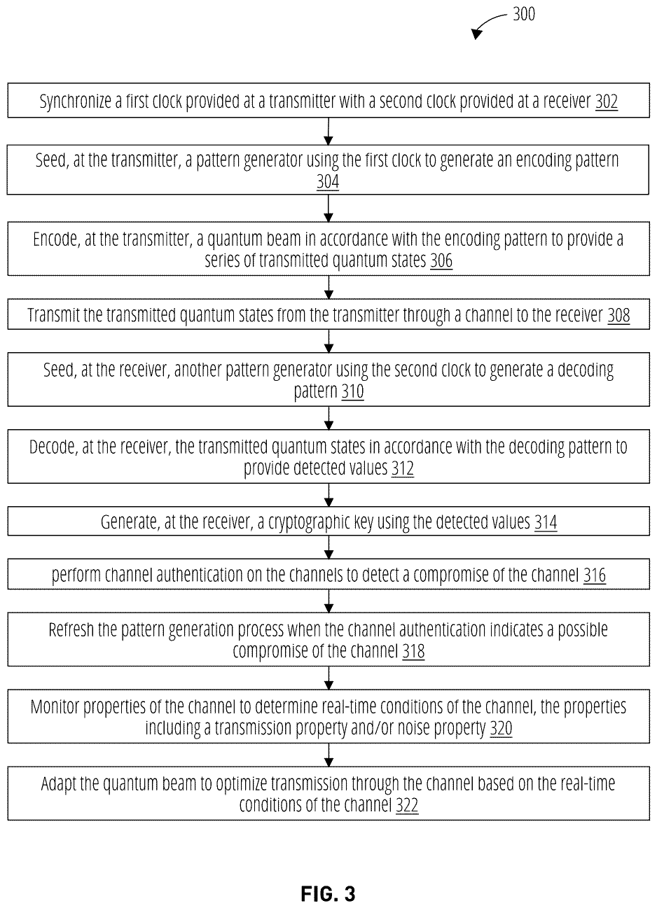

FIG. 3 illustrates an example method 300 for providing secure communications using a quantum communications system. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, step 302 of the method includes synchronizing a first clock provided at a transmitter with a second clock provided at a receiver. For example, synchronized timing device 112 provided at transmitter 110 may be synchronized with synchronized timing device 132 the second provided at receiver 130. This synchronization may be performed as discussed above for FIG. 1.

According to some examples, step 304 of the method includes seeding a pattern generator using the first clock to generate an encoding pattern. For example, the pattern generator 114 illustrated in FIG. 1 may se, at the transmitter, a pattern generator using the first clock to generate a encoding pattern. This generation of the encoding pattern may be performed as discussed above for FIG. 1.

According to some examples, step 306 of the method includes encoding a quantum beam in accordance with the encoding pattern to provide a series of transmitted quantum states. For example, modulator 118 illustrated in FIG. 1 may encode quantum beam 152 in accordance with encoding pattern generator 114 to provide a series of transmitted quantum states. This modulating of the quantum beam may be performed as discussed above for FIG. 1.

According to some examples, step 308 of the method includes transmitting the transmitted quantum states from the transmitter through a channel to the receiver at step 308. For example, channel 150 illustrated in FIG. 1 may transmit quantum beam 152 from transmitter 110 through channel 150 to receiver 130. This transmission of the quantum beam from the transmitter to the receiver may be performed as discussed above for FIG. 1.

According to some examples, step 310 of the method includes seeding, at the receiver, another pattern generator using the second clock to generate a decoding pattern at step 310. For example, synchronized timing device 132 may seed pattern generator 114 to generate demodulation pattern 172. This seeding of the pattern generator may be performed as discussed above for FIG. 1.

According to some examples, step 312 of the method includes decoding, at the receiver, the transmitted quantum states in accordance with the decoding pattern to provide detected values. For example, the demodulator 136 may demodulate quantum beam 152 to provide quantum elements 174 and quantum state detector 138 can measure the quantum states of quantum elements 174 to provide detected values 184. This detection of the quantum states may be performed as discussed above for FIG. 1.

According to some examples, step 314 the method includes generating, at the receiver, a cryptographic key using the decoded pattern. For example, the receiver 130 illustrated in FIG. 1 may generate a cryptographic key using the detected values 184. This generating of a cryptographic key may be performed as discussed above for FIG. 1.

According to some examples, step 316 the method includes performing channel authentication on the channels to detect a compromise of the channel. For example, receiver 130 and/or transmitter 110 illustrated in FIG. 1 may perform channel authentication on the channels to detect a compromise of the channel. This channel authentication may be performed as discussed above for FIG. 1

According to some examples, step 318 the method includes refreshing the pattern generation process when the channel authentication indicates a possible compromise of the channel at step 318. This refreshing of the pattern generation process may be performed as discussed above for FIG. 1.

According to some examples, step 320 the method includes monitoring properties of the channel to determine real-time conditions of the channel, the properties including a transmission property and/or noise property at step 320. This detection of real-time conditions of the channel may be performed as discussed above for FIG. 1.

According to some examples, step 322 the method includes adapting the quantum beam to optimize transmission through the channel based on the real-time conditions of the channel at step 322. This adapting of the quantum beam to optimize transmission may be performed as discussed above for FIG. 1.

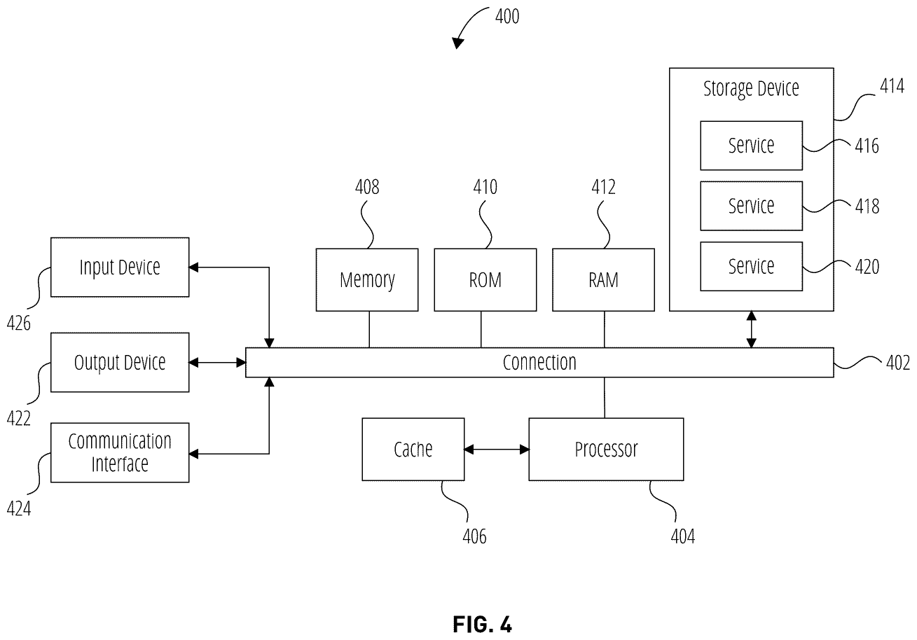

FIG. 4 shows an example of computing system 400. The computing system 400 can be a router, switch, network control appliance, network management appliance, or an analytics engine, for example. The computing system 400 can perform the functions of one or more of transmitter processor 188 or receiver processor 190. The computing system 400 can be part of a distributed computing network in which several computers perform respective steps in method 300 and/or the functions of transmitter processor 188 or receiver processor 190. The computing system 400 can be connected to the other parts of the distributed computing network via connection 402 or communication interface 424. Connection 402 can be a physical connection via a bus, or a direct connection into processor 404, such as in a chipset architecture. Connection 402 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 400 includes at least one processing unit or CPU (e.g., processor 404) and connection 402 that couples various system components including system memory 408, such as read-only memory (e.g., ROM 410) and random access memory (e.g., RAM 412) to processor 404. Computing system 400 can include a cache of high-speed memory 406 connected directly with, in close proximity to, or integrated as part of processor 404. Processor 404 may essentially be a completely self-contained computing system, containing multiple cores or processors, a bus, memory controller, cache, etc. A multi-core processor may be symmetric or asymmetric.

Processor 404 can include any general-purpose processor and a hardware service or software service, such as service 416, service 418, and service 420 stored in storage device 414, configured to control processor 404 as well as a special-purpose processor where software instructions are incorporated into the actual processor design.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include a communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some embodiments, a hardware service that performs a particular function can include the software component stored in a computer-readable medium in connection with the necessary hardware components, such as processor 404, connection 402, output device 422, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### ADDITIONAL CONSIDERATIONS

The foregoing described embodiments have been presented for the purpose of illustration; they are not intended to be exhaustive or to limiting to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, described modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include one or more general-purpose computing devices selectively activated or reconfigured by one or more stored computer programs. A computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Described embodiments may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

### ASPECTS

The present technology includes computer-readable storage mediums for storing instructions, and systems for executing any one of the methods embodied in the instructions addressed in the aspects of the present technology presented below:

Aspect 1. A method, comprising: synchronizing a first clock provided at a transmitter with a second clock provided at a receiver; seeding, at the transmitter, a first pattern generator using the first clock to generate an encoding pattern; encoding, at the transmitter, a quantum beam in accordance with the encoding pattern to provide an encoded quantum beam; transmitting the encoded quantum beam from the transmitter through a channel to the receiver to provide a received quantum beam; seeding, at the receiver, a second pattern generator using the second clock to generate a decoding pattern; and detecting, at the receiver, quantum states of the received quantum beam in accordance with the decoding pattern to provide detected values.

Aspect 2. The method of aspect 1, wherein: encoding the quantum beam at the transmitter further includes: obtaining a code word to be encoded on the encoded quantum beam, determining a first series of bases for respective quantum states of the encoded quantum beam based on the encoding pattern, and modulating the quantum beam based on the code word and the first series of bases to generate the encoded quantum beam, wherein a quantum state encoded on the quantum beam is based on a part of the code word and a basis in which the quantum state encoded is based on a basis of the first series of bases; and detecting the quantum states of the received quantum beam further includes: demodulating the quantum beam using a second series of bases represented by the decoding pattern to transform the bases of the quantum states in the received quantum beam to a measurement basis to provide a demodulated quantum beam, and detecting, at a detector, the quantum states of the demodulated quantum beam to generate the detected values.

Aspect 3. The method of aspect 1 or aspect 2, wherein: the quantum states of the quantum beam are near-vacuum qumodes of an optical field, and encoding the quantum beam includes applying at least one of a polarization modulation, an amplitude modulation, a phase modulation, or a quadrature modulation.

Aspect 4. The method of any of aspects 1-3, wherein: the first clock is a first atomic clock, the second clock is a second atomic clock, and the first atomic clock and the second atomic clock are synchronized such that the encoding pattern matches the decoding pattern.

Aspect 5. The method of any of aspects 1-4, wherein: encoding the quantum beam includes encoding a code word on the quantum beam by modulating quantum elements of the quantum beam to be in respective quantum states of respective bases, wherein the respective quantum states are based on the code word and the respective bases are based on the encoding pattern, and detecting the quantum states of the received quantum beam includes using the decoding pattern to determine the respective bases in which to measure, as the detected values, respective quantum states of the quantum elements of the received quantum beam.

Aspect 6. The method of aspect 5, further comprising: applying an error-correcting code to a message to generate the code word; and performing error correction on the detected values to recover the message from the detected values.

Aspect 7. The method of aspect 6, wherein the message includes a cryptographic key.

Aspect 8. The method of any of aspects 1-7, wherein: the quantum states of the quantum beam are qumodes for continuous-variable quantum information processing, and detecting the quantum states of the received quantum beam includes using homodyne detection or heterodyne detection techniques to measure quadratures of the qumodes.

Aspect 9. The method of any of aspects 1-8, wherein: the decoding pattern indicates bases in which the quantum states of the received quantum beam have been encoded, and the method further comprises: using, at the receiver, the decoding pattern to determine measurement bases for detecting the quantum states of the received quantum beam, and generating, at the receiver, a receiver message or cryptographic key that matches a transmitter message or cryptographic key, the receiver message or cryptographic key being generated from the detected values without sending, to the transmitter and via a classical communication channel, post-processing information about the measurement bases.

Aspect 10. The method of any of aspects 1-9, further comprising: generating a cryptographic key using the first clock and the second clock to coordinate state preparation bases at the transmitter with measurement bases at the receiver without communicating bases between the transmitter and the receiver via a classical communication channel.

Aspect 11. The method of any of aspects 1-10, further comprising: performing channel authentication on the channel to detect a compromise of the channel; and in response to detecting the compromise of the channel, refreshing a process used for seeding the first pattern generator using the first clock and seeding the second pattern generator using the second clock.

Aspect 12. The method of aspect 11, wherein performing the channel authentication includes: analyzing fluctuations in one or more fields propagating through the channels to detect an anomaly, and determining that channel is compromised when the anomaly is detected.

Aspect 13. The method of aspect 11, wherein refreshing the process used for seeding a given pattern generator includes changing the process from a first process to a second process, wherein a same input to the second process generates a different pattern than is generated using the first process.

Aspect 14. The method of any of aspects 1-13, further comprising: monitoring properties of the channel to determine real-time conditions of the channel; and dynamically adapting the quantum beam to optimize transmission through the channel based on the real-time conditions of the channel.

Aspect 15. The method of aspect 14, wherein the properties of the channel include at least one of an attenuation of the channel, a noise density of the channel, or a noise distribution of the channel.

Aspect 16. The method of any of aspects 1-15, further comprising: transmitting a classical signal carrying classical information through the channel simultaneously with transmitting the encoded quantum beam through the channel; separating, at the receiver, the classical signal from the encoded quantum beam, and processing the classical signal independently from the receiver.

Aspect 17. The method of aspect 16, wherein the classical signal is separated from the encoded quantum beam using wavelength division multiplexing.

Aspect 18. A communication system comprising: a transmitter that includes: a first pattern generator that receives a seed, and, in response to the seed, generates an encoding pattern; a quantum source that generates a quantum beam comprising a series of quantum units, each quantum unit of the series quantum units in an initial quantum state; a first modulator that receives the encoding pattern and changes the initial quantum state of a quantum unit of the quantum beam to a modulated quantum state in a first basis that is based on the encoding pattern to provide a modulated quantum beam having quantum units in modulated quantum states in first bases, wherein the transmitter transmits the modulated quantum beam through a channel to a receiver.

Aspect 19. The communication system of aspect 18, wherein: the transmitter further includes a first clock that is synchronized to a second clock of the receiver, and the first clock generates the seed and sends the seed to the first pattern generator.

Aspect 20. The communication system of aspect 18 or aspect 19, wherein; the first clock is an atomic clock, and the first clock is synchronized to the second clock such that the encoding pattern matches a decoding pattern of the receiver.

Aspect 21. The communication system of any of aspects 18-20, the first modulator receives a code word and the first modulator selects the modulated quantum states based on the code word and selects the first bases based on the encoding pattern.

Aspect 22. The communication system of aspect 21, wherein the transmitter further includes a processor that applies an error-correcting code to a message to generate the code word.

Aspect 23. The communication system of aspect 21, wherein the code word includes information of a cryptographic key.

Aspect 24. The communication system of any of aspects 18-23, wherein: the modulated quantum states are qumodes of an optical field, and the first modulator encodes the quantum beam by applying at least one of a polarization modulation, an amplitude modulation, a phase modulation, or a quadrature modulation.

Aspect 25. The communication system of any of aspects 18-24, wherein the modulated quantum states are qumodes of an optical field, and the modulator encodes information of a code word in quadratures of the qumodes.

Aspect 26. The communication system any of aspects 18-25, further comprising: the receiver that includes: a second pattern generator that receives another seed, and, in response to the another seed, generates a decoding pattern; a detector system that receives the decoding pattern and the modulated quantum beam, the detector system detecting the modulated quantum states by measuring respective quantum units of the modulated quantum beam using respective measurement bases that are based on the decoding pattern to generate detected values.

Aspect 27. The communication system of aspect 26, wherein the detector system includes: a second modulator that uses the decoding pattern to change the first bases of the quantum units of the modulated quantum beam to a measurement basis, and a detector that detects the modulated quantum states in the measurement basis to generate the detected values.

Aspect 28. The communication system of aspect 27, wherein: the quantum units of the modulated quantum beam are qumodes, and the detector uses homodyne detection or heterodyne detection to measure quadratures of the qumodes to generate the detected values.

Aspect 29. The communication system of aspect 27, wherein the receiver further includes a processor that performs error correction on the detected values to recover a message from the detected values.

Aspect 30. The communication system of aspect 27, wherein: the receiver further comprises a second clock that is synchronized to a first clock of the transmitter, and the second clock generates the another seed and sends the another seed to the second pattern generator.

Aspect 31. The communication system of aspect 30, wherein: the receiver further includes a processor that performs channel authentication to detect a compromise of the channel; and in response to detecting the compromise of the channel, the processor causes at least one of the second clock or the second pattern generator to refresh a process used for generating the decoding pattern.

Aspect 32. The communication system of aspect 31, wherein: the processor performs the channel authentication by: analyzing fluctuations in one or more fields propagating through the channels to detect an anomaly, and determining that channel is compromised when the anomaly is detected.

Aspect 33. The communication system of aspect 31, wherein refreshing the process used for generating the decoding pattern includes changing the process from a first process to a second process, wherein a same input to the second process generates a different pattern than is generated using the first process.

Aspect 34. The communication system of aspect 26, wherein the receiver further includes a processor that: monitors properties of the channel to determine real-time conditions of the channel; and dynamically adapts the quantum beam to optimize transmission through the channel based on the real-time conditions of the channel.

Aspect 35. The communication system of aspect 34, wherein the properties of the channel include at least one of an attenuation of the channel, a noise density of the channel, or a noise distribution of the channel.

Aspect 36. A communication system comprising: a receiver that includes: a pattern generator that receives a seed, and, in response to the seed, generates a decoding pattern; a detector system that receives the decoding pattern and a modulated quantum beam, the detector system detecting modulated quantum states by measuring respective quantum units of the modulated quantum beam using respective measurement bases that are based on the decoding pattern to generate detected values, wherein the decoding pattern is coordinated with an encoding pattern of a transmitter that generates the modulated quantum beam, and the receiver receives the modulated quantum beam from the transmitter via a channel.

Aspect 37. The communication system of aspect 36, wherein the detector system includes: a modulator that uses the decoding pattern to change bases of the quantum units of the modulated quantum beam to a measurement basis, and a detector that detects the modulated quantum states in the measurement basis to generate the detected values.

Aspect 38. The communication system of aspect 37, wherein: the quantum units of the modulated quantum beam are qumodes, and the detector uses homodyne detection or heterodyne detection to measure quadratures of the qumodes to generate the detected values.

Aspect 39. The communication system of aspect 37, wherein the receiver further includes a processor that performs error correction on the detected values to recover a message from the detected values.

Aspect 40. The communication system of aspect 37, wherein: the receiver further comprises a clock that is synchronized to another clock of the transmitter, and the clock generates the seed and sends the seed to the pattern generator to coordinate the decoding pattern with the encoding pattern of the transmitter.

Aspect 41. The communication system of aspect 40, wherein: the receiver further includes a processor that performs channel authentication to detect a compromise of the channel; and in response to detecting the compromise of the channel, the processor causes at least one of the clock or the pattern generator to refresh a process used for generating the decoding pattern.

Aspect 42. The communication system of aspect 41, wherein: the processor performs the channel authentication by: analyzing fluctuations in one or more fields propagating through the channels to detect an anomaly, and determining that channel is compromised when the anomaly is detected.

Aspect 43. The communication system of aspect 41, wherein refreshing the process used for generating the decoding pattern includes changing the process from a first process to a second process, wherein a same input to the second process generates a different pattern than is generated using the first process.

Aspect 44. The communication system of any of aspects 36-43, wherein the receiver further includes a processor that: monitors properties of the channel to determine real-time conditions of the channel; and dynamically adapts the quantum beam to optimize transmission through the channel based on the real-time conditions of the channel.

Aspect 45. The communication system of aspect 44, wherein the properties of the channel include at least one of an attenuation of the channel, a noise density of the channel, or a noise distribution of the channel.

What is claimed is:

1. A method, comprising:
synchronizing a first clock provided at a transmitter with a second clock provided at a receiver;
seeding, at the transmitter, a first pattern generator using the first clock to generate an encoding pattern;
encoding, at the transmitter, a quantum beam in accordance with the encoding pattern to provide an encoded quantum beam;
transmitting the encoded quantum beam from the transmitter through a channel to the receiver to provide a received quantum beam;
seeding, at the receiver, a second pattern generator using the second clock to generate a decoding pattern; and
detecting, at the receiver, quantum states of the received quantum beam in accordance with the decoding pattern to provide detected values.

2. The method of claim 1, wherein:
the quantum states of the quantum beam are near-vacuum qumodes of an optical field, and
encoding the quantum beam includes applying at least one of a polarization modulation, an amplitude modulation, a phase modulation, or a quadrature modulation.

3. The method of claim 1, wherein:
the first clock is a first atomic clock,
the second clock is a second atomic clock, and
the first atomic clock and the second atomic clock are synchronized such that the encoding pattern matches the decoding pattern.

4. The method of claim 1, wherein:
encoding the quantum beam includes encoding a code word on the quantum beam by modulating quantum elements of the quantum beam to be in respective quantum states of respective bases, wherein the respective quantum states are based on the code word and the respective bases are based on the encoding pattern, and
detecting the quantum states of the received quantum beam includes using the decoding pattern to determine the respective bases in which to measure, as the detected values, respective quantum states of the quantum elements of the received quantum beam.

5. The method of claim 4, further comprising:
applying an error-correcting code to a message to generate the code word; and
performing error correction on the detected values to recover the message from the detected values.

6. The method of claim 1, wherein:
the quantum states of the quantum beam are qumodes for continuous-variable quantum information processing, and
detecting the quantum states of the received quantum beam includes using homodyne detection or heterodyne detection to measure quadratures of the qumodes.

7. The method of claim 1, wherein:
the decoding pattern indicates bases in which the quantum states of the received quantum beam have been encoded, and
the method further comprises:
using, at the receiver, the decoding pattern to determine measurement bases for detecting the quantum states of the received quantum beam, and
generating, at the receiver, a receiver message or cryptographic key that matches a transmitter message or cryptographic key, the receiver message or cryptographic key being generated from the detected values without sending, to the transmitter and via a classical communication channel, post-processing information about the measurement bases.

8. The method of claim 1, further comprising:
performing channel authentication on the channel to detect a compromise of the channel; and
in response to detecting the compromise of the channel, refreshing a process used for seeding the first pattern generator using the first clock and seeding the second pattern generator using the second clock.

9. The method of claim 8, wherein performing the channel authentication includes:
analyzing fluctuations in one or more fields propagating through the channels to detect an anomaly, and
determining that channel is compromised when the anomaly is detected.

10. The method of claim 1, further comprising:
monitoring properties of the channel to determine real-time conditions of the channel; and
dynamically adapting the quantum beam to optimize transmission through the channel based on the real-time conditions of the channel.

11. A communication system comprising:
a transmitter that includes:
a first pattern generator that receives a seed, and, in response to the seed, generates an encoding pattern;
a quantum source that generates a quantum beam comprising a series of quantum units, each quantum unit of the series quantum units in an initial quantum state;
a first modulator that receives the encoding pattern and changes the initial quantum state of a quantum unit of the quantum beam to a modulated quantum state in a first basis that is based on the encoding pattern to provide a modulated quantum beam having quantum units in modulated quantum states in first bases, wherein
the transmitter transmits the modulated quantum beam through a channel to a receiver.

12. The communication system of claim 11, wherein:
the transmitter further includes a first clock that is synchronized to a second clock of the receiver, and the first clock generates the seed and sends the seed to the first pattern generator.

13. The communication system of claim 11, the first modulator receives a code word and the first modulator selects the modulated quantum states based on the code word and selects the first bases based on the encoding pattern.

14. The communication system of claim 11, wherein the modulated quantum states are qumodes of an optical field, and the modulator encodes information of a code word in quadratures of the qumodes.

15. The communication system of claim 11, further comprising:
the receiver that includes:
a second pattern generator that receives another seed, and, in response to the another seed, generates a decoding pattern;
a detector system that receives the decoding pattern and the modulated quantum beam, the detector system detecting the modulated quantum states by measuring respective quantum units of the modulated quantum beam using respective measurement bases that are based on the decoding pattern to generate detected values.

16. A communication system comprising:
a receiver that includes:
a pattern generator that receives a seed, and, in response to the seed, generates a decoding pattern;
a detector system that receives the decoding pattern and a modulated quantum beam, the detector system detecting modulated quantum states by measuring respective quantum units of the modulated quantum beam using respective measurement bases that are based on the decoding pattern to generate detected values, wherein
the decoding pattern is coordinated with an encoding pattern of a transmitter that generates the modulated quantum beam, and
the receiver receives the modulated quantum beam from the transmitter via a channel.

17. The communication system of claim 16, wherein the detector system includes:
a modulator that uses the decoding pattern to change bases of the quantum units of the modulated quantum beam to a measurement basis, and
a detector that detects the modulated quantum states in the measurement basis to generate the detected values.

18. The communication system of claim 17, wherein:
the quantum units of the modulated quantum beam are qumodes, and
the detector uses homodyne detection or heterodyne detection to measure quadratures of the qumodes to generate the detected values.

19. The communication system of claim 17, wherein:
the receiver further comprises a clock that is synchronized to another clock of the transmitter, and the clock generates the seed and sends the seed to the pattern generator to coordinate the decoding pattern with the encoding pattern of the transmitter.

20. The communication system of claim 19, wherein:
the receiver further includes a processor that performs channel authentication to detect a compromise of the channel; and
in response to detecting the compromise of the channel, the processor causes at least one of the clock or the pattern generator to refresh a process used for generating the decoding pattern.

21. The communication system of claim 20, wherein:
the processor performs the channel authentication by:
analyzing fluctuations in one or more fields propagating through the channels to detect an anomaly, and
determining that channel is compromised when the anomaly is detected.

22. The communication system of claim 16, wherein the receiver further includes a processor that:
monitors properties of the channel to determine real-time conditions of the channel; and
dynamically adapts the quantum beam to optimize transmission through the channel based on the real-time conditions of the channel.
